(19) United States
(12) Patent Application Publication
(10) Pub. No.: US 2026/0179189 A1
(43) Pub. Date: Jun. 25, 2026

(54) SYSTEM AND METHOD FOR NOISE-ENABLED STATIC IMAGING USING EVENT CAMERAS

(71) Applicant: THE REGENTS OF THE UNIVERSITY OF CALIFORNIA, Oakland, CA (US)

(72) Inventors: Dekel Galor, Berkeley, CA (US); Ruiming Cao, Berkeley, CA (US); Laura Waller, Berkeley, CA (US); Jacob Yates, Berkeley, CA (US)

(73) Assignee: THE REGENTS OF THE UNIVERSITY OF CALIFORNIA, Oakland, CA (US)

(21) Appl. No.: 19/445,771

(22) Filed: Jan. 12, 2026

Related U.S. Application Data
(63) Continuation of application No. PCT/US2024/040043, filed on Jul. 29, 2024.
(60) Provisional application No. 63/515,889, filed on Jul. 27, 2023.

(51) Int. Cl. G06T 5/50; G06T 5/40; G06T 5/70; G06T 5/92; G06T 7/80; H04N 25/47

(52) U.S. Cl. CPC G06T 5/50; G06T 5/40; G06T 5/70; G06T 5/92; G06T 7/80; H04N 25/47; G06T 2207/20084; G06T 2207/20208; G06T 2207/20216

(57) ABSTRACT

Standard event-based cameras capture changes in luminance with high temporal resolution, but they do not measure static images. An event-based imaging system and methods that can capture static intensity is provided that eliminates the need for a dual-sensing system and significantly reduces the cost, footprint, and data bandwidth of the imaging system. The system is suited for applications where high temporal resolution and dynamic range are required, but where static scene information is also important. The system has a Dynamic Vision Sensor for capturing data and a processing unit for data aggregation, a fast approximate extraction of static information from noise, and scene reconstruction. The methods may use a model for reconstruction or may calibrate during system deployment by making measurements of known static luminance and recording average noise levels over a predetermined period to map between luminance and noise for reconstruction.

### CROSS-REFERENCE TO RELATED APPLICATIONS

This application claims priority to, and is a 35 U.S.C. § 111(a) continuation of, PCT international application number PCT/US2024/040043 filed on Jul. 29, 2024, incorporated herein by reference in its entirety, which claims priority to, and the benefit of, U.S. provisional patent application Ser. No. 63/515,889 filed on Jul. 27, 2023, incorporated herein by reference in its entirety. Priority is claimed to each of the foregoing applications.

The above-referenced PCT international application was published as PCT International Publication No. WO 2025/024853 A2 on Jan. 30, 2025, which publication is incorporated herein by reference in its entirety.

### STATEMENT REGARDING FEDERALLY SPONSORED RESEARCH OR DEVELOPMENT

This invention was made with government support under Grant Number R00 EY032179 awarded by the National Eye Institute (NIH). The government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to capturing images with event-based cameras, and more particularly to capturing static intensity information from noise.

### 2. Background Discussion

Event cameras, also known as neuromorphic cameras or dynamic vision sensors, are an emerging modality for capturing dynamic scenes. Although event-based cameras capture changes in luminance with unparalleled temporal resolution, they do not measure static images. The inability of event cameras to capture static intensity information historically necessitates the use of a dual-sensing system, combining a traditional sensor with an event-based one for various applications such as industrial automation, IoT & monitoring, automotive & mobility, and medicine.

Their ability to capture data at a much faster rate compared to conventional cameras have led to event camera use in high-speed navigation, augmented reality, and real-time 3D reconstruction. For example, Dynamic Vision Sensors (DVS), also known as event cameras or neuromorphic sensors, enable extremely high temporal resolution and dynamic range compared to traditional sensors. However, DVS pixels only capture changes in intensity and discards all static information. To overcome this issue, an additional photosensor array is needed either (1) in a two-sensor system or (2) combined into a single sensor with two-pixel technologies (e.g., DAVIS346). In both cases, the resulting system is bulkier, more complex to design, and more expensive to manufacture.

Unlike a conventional CMOS camera, that outputs intensity images at fixed intervals, an event camera detects brightness changes at each pixel asynchronously. When the change in brightness at a pixel exceeds some threshold, an event is recorded. The output from a typical event camera consists of three elements: a timestamp, the spatial coordinate of the triggered pixel, and a binary polarity, indicating whether it is an increase or decrease of brightness.

While this scheme allows event cameras to operate beyond conventional framerates, it makes them blind to the stationary components of a scene, which induce no brightness changes over time. This issue is especially prevalent when the camera is not moving and therefore provides no information about the static background.

Even though event cameras are not designed to capture an intensity image, they are often needed for downstream applications such as initializing motion tracking algorithms. To mitigate this issue, some event cameras include a conventional frame-based sensor in the pixel circuit to simultaneously image both events and traditional intensity images. Alternatively, when circuit level modification of the event camera is not possible, a frame-based camera can be installed in parallel, using either a beam splitter or additional view registration. Both of these solutions introduce additional hardware complexity, size, and power consumption as well as increased cost.

Therefore, there is a need for a solution that does not require using two-pixel technologies that is reliable with low power demands.

### BRIEF SUMMARY

Systems and methods for event camera-based imaging are presented that extract underlying static intensity information directly from Dynamic Vision Sensor (DVS) pixels, thereby avoiding the need for the use of conventional two-pixel technologies. By capturing static intensity, which thereby eliminates the need for a dual-sensing system, the methods significantly reduce the cost, footprint, and data bandwidth of the imaging system.

The methods leverage the fact that, even when the scene is static, event cameras still produce noise events. While the photon noise is well-studied in the context of frame-based scenes, those events triggered by photon noise are commonly deemed as part of the general background noise activity of the event-based sensor that needs to be filtered out.

The methods presented can reconstruct a static scene from its event noise statistics, with no hardware modifications and negligible computational overhead. A statistical noise model can be derived describing how noise event generation correlates with scene intensity, which shows a good correspondence with experimental measurements. The noise event generation due to photon noise can be characterized with a mathematical model describing the statistical relationship between noise events and pixel illuminance.

Unlike in conventional sensors, where photon noise grows with the signal, it has been observed with event cameras that the number of events triggered by photon noise is mostly negatively correlated with the illuminance level due to the logarithmic sensitivity of the sensor. Imaging the static scene then amounts to inverting this intensity-to-noise process.

In one embodiment of the method, the intensity image of a static scene from a recording of noise events is recovered using a learned prior. However, the mapping is one-to-many and not directly invertible; thus, the methods may rely on a learned prior to resolve any ambiguities. In one embodiment of the method, the intensity image of a static scene from a recording of noise events is recovered using a learned prior. In another embodiment, noise-events-to-image datasets are collected with recordings of noise events paired with the corresponding intensity images to train an algorithm.

Although the system design is extremely adaptive to the specific application, in one embodiment, there are preferably two key components that all variations share: (a) Dynamic Vision Sensor for capturing data; and (b) a processing unit to manage data aggregation, extraction and scene reconstruction.

In one embodiment, the process for reconstructing exact scene luminance values from noise involves the following four stages: (a) Calibration performed during system deployment. This process involves making measurements of known static luminosities and recording average noise levels over a predetermined period. This results in a known mapping between luminance and noise. (b) Capturing static scenes at runtime and recording average noise levels. (c) Reconstructing the estimated scene using the calibrated mapping. (d) Optional denoising.

In another embodiment, the system captures static scenes at runtime and records average noise levels. An inversion of noise to account for the inverse relationship between noise and luminance is optionally performed. Then a histogram equalization is applied with a predetermined number of bins to enhance the contrast of the noise.

In another embodiment, intensity-aware adaptive denoising is accomplished using the static scene estimate for calculating likelihoods of each event being noise by: (a) Estimating static scene at runtime over a specified time scale. (b) Using the known physics of noise generation (see papers section) to estimate the expected noise distribution given our estimate of the static scene, and (c) Assign each event a likelihood of being noise conditioned on the estimated static scene, which can be used for empirically choosing a threshold for denoising.

In a further embodiment, the process can simultaneously denoise and estimate the static scene, thereby reducing the amount of computation and improving the quality of the two resulting signals by: (a) estimating event likelihoods of being noise using the previous process; (b) optionally supplementing the likelihoods using existing denoising metrics using a weighted average selected empirically, and (c) using an empirically selected threshold to separate events into two channels, signal, and noise. The signal can be passed to downstream processes, while the noise can be used for simultaneously estimating the static scene.

The extraction of static information leverages inherent hardware properties and as such does not impact the design process of the sensor. This also means that it does not add cost and can be used in any stage of the imaging pipeline. When extracting the static scene, the time of integrating information for reconstruction is correlated to the quality and dynamic range of the estimated static scene, effectively enabling extreme HDR imaging capabilities (analogous to taking many images at different exposures with a regular camera). By separating out the noise that results from the static scene information, we can also take steps to remove that noise from the DVS signal for better performance on downstream tasks. Some major advantages in relation to dual-sensor systems include:

(a) Much lower cost (no additional costs to one sensor system).

(b) Smaller data bandwidth (no need to process data from a second sensor).

(c) Simpler circuit and system design.

Smaller footprint given the same DVS capabilities.

(d) Can be applied to existing recordings.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a functional block diagram of a method for event camera-based imaging that extracts underlying static intensity information directly from Dynamic Vision Sensor (DVS) pixels using the system according to one embodiment of the technology.

FIG. 2 is a functional block diagram of an alternative implementation that employs fast approximate extraction of static information from noise, broken into three stages according to another embodiment of the technology.

FIG. 3 is a graph illustrating the correlation between static scene intensity and the average noise in events per second, as measured empirically for Sony IMX636 DVS sensor using Prophesee Metavision® EVK3-HD evaluation kit.

FIG. 4 depicts images illustrating a prototype reconstruction process done empirically. The ground truth was displayed on a 1080p monitor and captured using a Sony IMX636 DVS sensor using Prophesee Metavision® EVK3-HD evaluation kit. The left panel shows pure inverted noise aggregated over 1 s. The middle panel illustrates the effects of histogram equalization on the left panel. The right panel shows the ground truth of the reconstruction.

### DETAILED DESCRIPTION

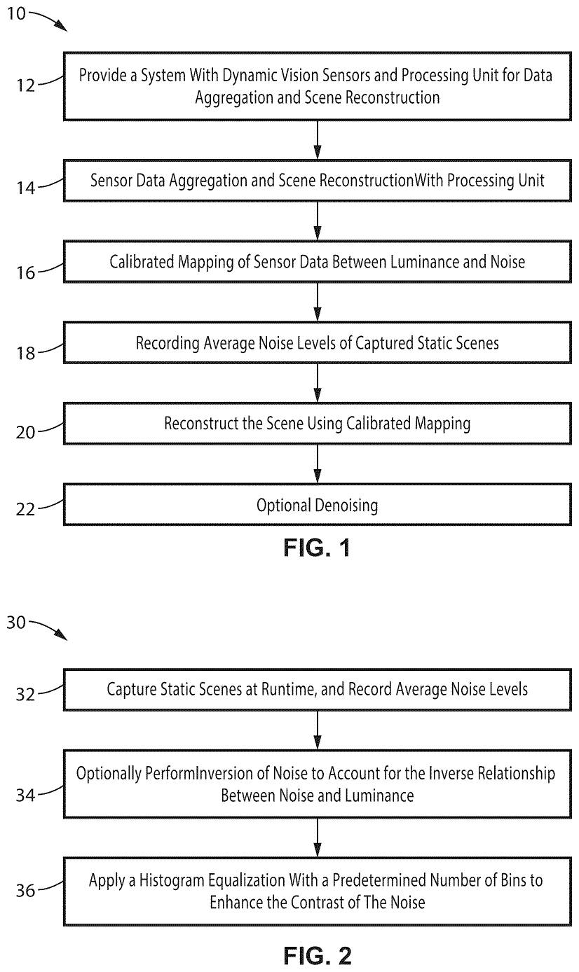

Referring more specifically to the drawings, for illustrative purposes, compositions, materials and methods for event camera-based imaging are generally shown. Several embodiments of the technology are described generally in FIG. 1 to FIG. 4 to illustrate the characteristics and functionality of the event camera-based imaging system and processing methods are presented that extract underlying static intensity information directly from Dynamic Vision Sensor (DVS) pixels, thereby avoiding the need for the use of conventional two-pixel technologies. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, a schematic block diagram of a method 10 for event camera-based imaging recovering intensity images solely from noise events that captures static scenes in event cameras, without additional hardware. At block 12 of FIG. 1, an event camera system is provided that is preferably equipped with a Dynamic Vision Sensor (DVS) and computer processor hardware and programming for data acquisition, aggregation and scene reconstruction.

Although the system design is extremely adaptive to the specific application, there are two key components that all variations share: (a) Dynamic Vision Sensor for capturing data, and (b) a processing unit to handle data aggregation and scene reconstruction at block 12.

Initially, the system acquires and aggregates data from the DVS sensor with the processing unit at block 14. Recorded events may be first separated into noise events and signal events using an existing event denoiser.

Event cameras capture changes of intensity over time as a stream of “events” and generally cannot measure intensity itself; hence, they are only used for imaging dynamic scenes. However, fluctuations due to random photon arrival inevitably trigger noise events, even for static scenes. While previous efforts have been focused on filtering out these undesirable noise events to improve signal quality, in the photon-noise regime, these noise events can be correlated with the static scene intensity.

Generally, the methods use signal events that are triggered by intensity changes of the scene. The noise events are then used to reconstruct the static scene intensity with the methods. This relies on characterizing the relationship between noise events and using learned priors to resolve ambiguities.

The noise event generation can be analyzed to model its relationship to illuminance. Based on this understanding, the methods leverage the illuminance-dependent noise characteristics to recover the static parts of a scene, which are otherwise invisible to event cameras. Data sets of noise events on static scenes can be collected to train and validate the reconstruction methods. The methods can robustly recover intensity images solely from noise events that capture static scenes in event cameras, without additional hardware.

The extraction of static information leverages inherent hardware properties and as such does not impact the design process of the DVS sensor. The system and methods do not add costs and can be used in any stage of the imaging pipeline. When extracting the static scene, the time of integrating information for reconstruction is correlated to the quality and dynamic range of the estimated static scene, effectively enabling extreme HDR imaging capabilities (analogous to taking many images at different exposures with a regular camera). By separating out the noise that results from the static scene information, it is possible to take steps to remove that noise from the DVS signal for better performance on downstream tasks.

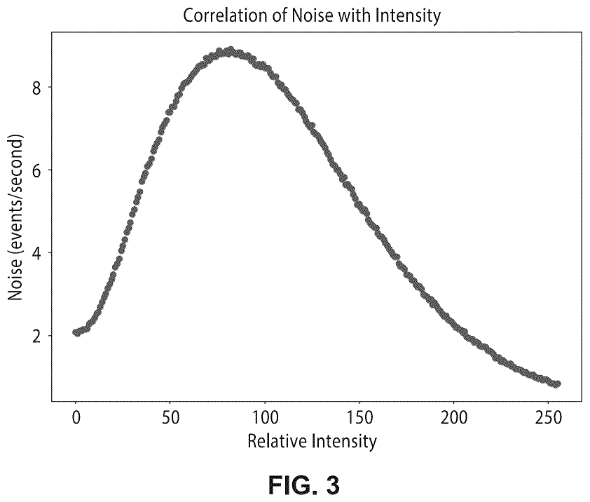

In the embodiment shown in FIG. 1, the process for reconstructing exact scene luminance values from noise preferably involves the following four stages:
(a) Calibration performed during system deployment takes place at block 16. This process involves making measurements of known static luminances and recording average noise levels over a predetermined period at block 18. This results in a known mapping between luminance and noise, as shown in FIG. 3;
(b) Capturing static scenes at runtime and then recording average noise levels at block 18;
(c) Reconstructing the estimated scene at block 20 using the calibrated mapping data from block 18; and
(d) Optional denoising at block 22.

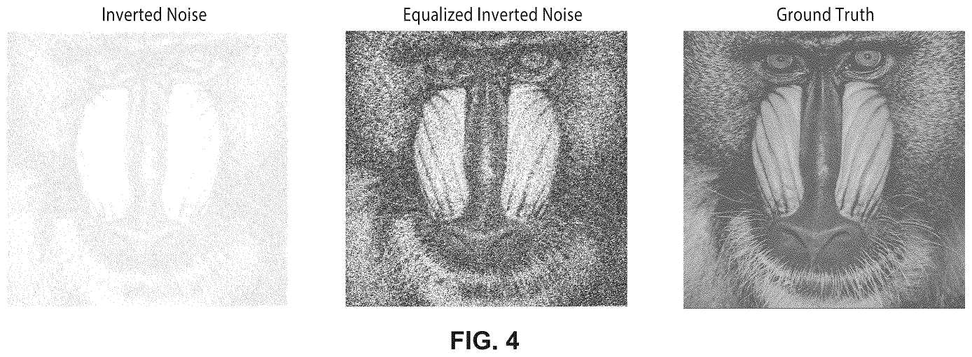

The mapping at block 16 normally exists only when the scene's dynamic range is limited to a monotonic portion of the mapping curve. A part of the mapping curve we recorded is illustrated in FIG. 3. In the case where the scene's dynamic range is not limited to a monotonic portion of the mapping curve, recovering exact luminance values may not be possible. However, most applications may only require accurate contrast over luminance. In addition, for many applications calibration may be cumbersome or undesirable. For those issues, the core reconstruction process is extended. In this embodiment, a simple and fast algorithm that gives good spatial details and requires no calibration, and no prior information about the scene may be used. Some empirical results are shown in FIG. 4, for example.

In another embodiment, the methods employ fast approximate extraction of static information 30 from noise, broken into three stages as shown in FIG. 2. The first stage 32 is (a) to capture static scenes at runtime, and then record average noise levels. The second stage 34 is the (b) optional inversion of noise (i.e., max value of noise-noise) to account for the inverse relationship between noise and luminance. The third stage 36 is to (c) apply histogram equalization with a predetermined number of bins to enhance the contrast of the noise. The ideal number of bins is reliant upon the dynamic range of the reconstruction, which is reliant on the length of the noise recording (longer exposure->more bins).

In addition to the core reconstruction processes illustrated above, there are various additional and alternative processes that can improve upon the results. The first alternative process involves data-driven extraction of static information from noise via end-to-end optimization as follows:
(a) Collect a dataset with pairs of event data and corresponding static scene;
(b) Use optimization to learn a mapping between event data to static scene. This mapping can be flexibly chosen to accommodate for the processing power of the system. Some examples may include a lookup table, a neural network, or a linear mapping, etc.; and
(c) Apply the model at runtime on the processing unit to estimate static scene.

A second example of an alternative process includes an iterative inversion of static information from noise. This area is rich in variations, some of which include:

(a) Using classical priors on the scene.

(b) Using generative priors for inversion.

(c) Creating a forward model of scene to noise and inverting it iteratively.

Lastly, any of the previous methods may be supplemented by introducing postprocessing steps that try to bridge the gap between a reconstruction and the original static scene. These may include classical denoising techniques, or modern neural denoising techniques that can vastly improve the aesthetic qualities of the reconstruction.

While denoising methods for CMOS or CCD sensors often focus on building an accurate noise model, event camera denoising methods instead emphasize noise detection by identifying the “signal” events corresponding to changes in the scene and removing everything else. Because natural scene changes are inherently spatiotemporal, an event triggered by real signal should be accompanied by a number of other events at the neighboring spatial and temporal locations.

While the methods focus on using the static scene estimation for downstream tasks, another important application is denoising of the camera itself. The following processes aim to accomplish intensity-aware adaptive denoising. The first part involves using the static scene estimate for calculating likelihoods of each event being noise:

(b) Use the known physics of noise generation to estimate the expected noise distribution given our estimate of the static scene.

(a) Estimate static scene at runtime over a specified time scale.

(c) Assign each event a likelihood of being noise conditioned on the estimated static scene, which can be used for empirically choosing a threshold for denoising.

The following process uses the previous description to simultaneously denoise and estimate the static scene, thereby reducing the amount of computation and improving the quality of the two resulting signals:

(a) Estimate event likelihoods of being noise using the previous process.

(b) Supplement the likelihoods using existing denoising metrics using a weighted average selected empirically. This step is optional.

(c) Using an empirically selected threshold, separate events into two channels, signal, and noise. The signal can be passed to downstream processes, while the noise can be used for simultaneously estimating the static scene.

The technology described herein may be better understood with reference to the accompanying examples, which are intended for purposes of illustration only and should not be construed as in any sense limiting the scope of the technology described herein as defined in the claims appended hereto.

### Example 1

To demonstrate the fast approximate extraction of static information from noise, a setup of a DVS camera and a storage device was evaluated. The DVS camera was connected to a computer where the acquired data can be stored. The default DVS camera parameter settings (by Prophesee Metavision software) were used for the acquisition.

The camera was pointed to the scene that was to be imaged and the sequence of events was started and recorded for a certain period of time. In practice, an event recording for one second is often sufficient.

In the collected sequence of events, all the events were traversed and counted for the number of events for each pixel. In practice, the methods do not differentiate between ON and OFF events. The ON and OFF events were counted together.

Since the number of noise events is often inversely correlated with the luminance level, the methods computed the inverted event count by subtracting the calculated event count from the maximum possible event count for any pixels. The pixel having the highest event count will have the lowest inverted event count. Then a histogram equalization on the inverted event count to enhance the contrast was applied. The resulting image is the final static image reconstruction, as shown in FIG. 4.

The noise behavior of event cameras depends on many factors such as DVS circuit design and bias parameter settings. To recover the exact luminance from a sequence of noise events, the camera was calibrated for the noise response at different luminance levels. Then the DVS camera was pointed to a computer monitor. The monitor should have no backlight strobing/black frame insertion to ensure flicker does not drive events. The monitor was programmed to display grayscale luminance, ranging from the lowest possible luminance level (black color) to the highest luminance level (white color). For each luminance level displayed, we use the DVS camera to record the noise events for t_calibration seconds (t_calibration=1 was selected). Since the monitor did not flicker or change in the displayed gray level, all the of the events recorded were due to noise.

With the calibration noise events collected, the number of noise events over all the pixels at each luminance level was counted and the correlation curve between static scene intensity and the average noise in events per second was plotted as shown in FIG. 3.

Given the collected sequence of events, the number of events on each pixel, regardless of their polarity (ON or OFF events) was counted. This allowed the calculation of the event rate for each pixel by dividing the event count by recording time.

Next, the luminance values for each pixel were reconstructed using the calibration data collected in the first step. For each pixel, the intensity value from the calibration data that has the noise rate closest to the measured event rate was identified.

The previous step gave a good initial estimation of the static image. However, as illustrated in FIG. 3, the mapping from event rate to luminance level is not always one-to-one. There could be ambiguity in the exact luminance reconstruction. To resolve the ambiguity and improve the reconstruction quality, the total variation regularization was added to the reconstructed image and the Alternating Direction Method of Multipliers (ADMM) optimization method was applied for the reconstruction. ADMM split the optimization into three steps: 1) it first updates to improve the fitting over data consistency in x-update step, 2) the updated value is then refined based on the total variation regularization term (z-update), and 3) the discrepancies in 1) and 2) are balanced in u-update. These ADMM steps are repeated until either a maximum number of iterations is reached or the change of image between successive iterations is below a threshold.

### Example 2

An example of Python code describing and implementing the core aspects of the technology is set forth in Table 1.

The technology is well-suited for applications where high temporal resolution and dynamic range are required, but where static scene information is also important. These applications include, but are not limited to, industrial automation, IoT & monitoring, automotive & mobility, and medicine.

For example, in the automotive industry, this technology can be used in advanced driver-assistance systems (ADAS) and autonomous vehicles to provide real-time information about the environment. The high temporal resolution of event cameras can capture fast-moving objects, while the static scene information can provide context about the environment.

In medicine, this technology can be used in surgical robots to provide high-resolution, real-time imaging. The high temporal resolution can capture fast movements of the surgeon or patient, while the static scene information can provide context about the surgical site.

The technology can be used in security cameras to provide high-resolution, real-time imaging. The high temporal resolution of event cameras can capture fast-moving objects or individuals, which is crucial for detecting and tracking potential threats. The ability to extract static scene information can provide important context about the environment, such as the layout of a room or the presence of static objects. This can help in identifying changes in the scene over time, such as the movement of objects or the appearance of new objects.

Moreover, the high dynamic range of event cameras can be particularly useful for security applications, as they can operate effectively in a wide range of lighting conditions, from bright daylight to low-light nighttime scenes. The ability to extract static scene information can also help in identifying details that might be missed by traditional cameras in challenging lighting conditions.

For scene monitoring, such as in wildlife observation or industrial process monitoring, the invention can provide high-resolution, real-time information about the scene. The high temporal resolution can capture fast changes in the scene, while the static scene information can provide context about the environment. This can help in identifying patterns or anomalies in the scene, which can be crucial for understanding animal behavior or detecting faults in an industrial process.

The technology can significantly reduce the cost, footprint, and data bandwidth of the imaging system, as it eliminates the need for a dual-sensing system. This can make the technology more accessible and scalable for a wide range of applications.

For industrial automation, the ability to capture static scene information can provide important context about the environment, which can help in tasks such as object detection, tracking, and manipulation.

Additionally, for Internet of Things (IoT) and monitoring, the technology can be used in IoT devices for real-time monitoring of environments. The high temporal resolution can capture fast changes in the scene, while the static scene information can provide context about the environment.

The technology can also be used in existing systems as an afterthought, providing a cost-effective way to enhance the capabilities of existing event cameras. Furthermore, by separating out the noise that results from the static scene information, the technology can also help to improve the performance of event cameras in noisy environments.

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A system for noise-enabled static imaging using an event camera, the system comprising: (a) a dynamic vision sensor configured for capturing image data; and (b) a processor configured to receive captured image data from the dynamic vision sensor; and (c) a non-transitory memory storing instructions executable by the processor; (d) wherein the instructions, when executed by the processor, perform the steps comprising: (i) capturing and recording image data from the dynamic vision sensor; (ii) aggregating noise events from the recorded image data and recording average noise levels; and (iii) reconstructing an estimated scene using a calibrated mapping model.

The system of any preceding or following implementation, further comprising a data storage device and a display.

The system of any preceding or following implementation, wherein the instructions perform further steps comprising capturing static scenes at runtime and recording average noise levels and applying histogram equalization with a predetermined number of bins to enhance the contrast of the noise.

The system of any preceding or following implementation, wherein the instructions perform further steps comprising capturing static scenes at runtime and recording average noise levels; performing an inversion of noise to account for an inverse relationship between noise and luminance; and applying histogram equalization with a predetermined number of bins to enhance the contrast of the noise.

The system of any preceding or following implementation, wherein the inversion of noise comprises an iterative inversion of static information from noise selected from the group of applying classical priors on the scene, applying generative priors for inversion, and creating a forward model of scene to noise and inverting it iteratively.

The system of any preceding or following implementation, wherein the instructions perform further steps comprising performing a system calibration by making measurements of known static luminosities; recording average noise levels over a predetermined period; and producing a model of calibrated mapping between luminance and noise.

The system of any preceding or following implementation, wherein the instructions perform further steps comprising: collecting a dataset of pairs of event data and a corresponding static scene; optimizing a mapping between event data to static scene to produce an optimized model; and applying the optimized model at runtime to estimate the static scene.

The system of any preceding or following implementation, wherein the mapping is optimized with one or more of a lookup table, a neural network and a linear mapping.

The system of any preceding or following implementation, wherein the instructions perform further steps comprising: denoising the reconstructed estimated scene.

The system of any preceding or following implementation, wherein the instructions perform further steps comprising: estimating a static scene at runtime over a specified time scale; estimating a noise event distribution from the estimate of the static scene; assigning each event a likelihood of being noise conditioned on the estimated static scene; and selecting a threshold for denoising from the assigned noise event distribution.

The system of any preceding or following implementation, wherein the instructions perform further steps comprising using the selected threshold to separate events into a noise channel and a signal channel.

The system of any preceding or following implementation, wherein the instructions perform further steps comprising applying a weighted average selected empirically to the likelihood of being a noise event assignment.

A method for noise-enabled static imaging using an event camera, the method comprising: (a) capturing image data with a dynamic vision sensor; (b) capturing static scenes at runtime and recording average noise levels; and (c) reconstructing the estimated scene using a calibrated mapping model.

The method of any preceding or following implementation, further comprising performing a system calibration by making measurements of known static luminosities; recording average noise levels over a predetermined period; and producing a model of calibrated mapping between luminance and noise.

The method of any preceding or following implementation, further comprising capturing static scenes at runtime and recording average noise levels and applying histogram equalization with a predetermined number of bins to enhance the contrast of the noise.

The method of any preceding or following implementation, further comprising performing an inversion of noise to account for an inverse relationship between noise and luminance prior to histogram equalization.

The method of any preceding or following implementation, wherein the inversion of noise comprises an iterative inversion of static information from noise selected from the group of applying classical priors on the scene, applying generative priors for inversion, and creating a forward model of scene to noise and inverting it iteratively.

The method of any preceding or following implementation, further comprising: collecting a dataset of pairs of event data and a corresponding static scene; optimizing a mapping between event data to static scene to produce an optimized model; and applying the optimized model at runtime to estimate the static scene.

The method of any preceding or following implementation, further comprising denoising the reconstructed estimated scene.

A method for noise-enabled static imaging using an event camera, the method comprising: (a) capturing image data with a dynamic vision sensor; (b) performing calibration by making measurements of known static luminosities and recording average noise levels over a predetermined period, resulting in a calibrated mapping between luminance and noise; (c) capturing static scenes at runtime, and recording average noise levels; and (d) reconstructing the estimated scene using the calibrated mapping.

The method of any preceding or following implementation, further comprising: capturing static scenes at runtime and recording average noise levels; optionally performing inversion of noise to account for the inverse relationship between noise and luminance; and applying histogram equalization with a predetermined number of bins to enhance the contrast of the noise.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C,” within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment,” “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

### Table 1

import numpy as np
import scipy.sparse as sparse
event_height, event_width=720, 1280 # The pixel size of the camera
eps=1e-9 # A small number to prevent division by zero
′″
   event_structured_array is a structured array of events.
   event_structured_array[“t”] is the timestamp of each event.
   event_structured_array[“x”] is the x position of each event.
   event_structured_array[“y”] is the y position of each event.
#<HELPER FUNCTIONS>
def image_histogram_equalization(image, number_bins=256):
   ′″
      This function performs histogram equalization on an image.
   ′″
   image_histogram, bins=np.histogram(image.flatten( ), number_bins, density=True)
   cdf=image_histogram.cumsum( )
   cdf=(number_bins−1)*cdf/cdf[−1]
   image_equalized=np.interp(image.flatten( ), bins[:−1], cdf)
   return image_equalized.reshape(image.shape)
def events_to_event_sums(event_structured_array):
   ′″
      This function efficiently converts a structured array of events to a 2D array of event sums.
   ′″
   x_position_of_events=event_structured_array[“x”]
   y_position_of_events=event_structured_array[“y”]
   num_events=len(event_structured_array)
   return sparse.coo_matrix(
      (
         np.ones(num_events), \
         (y_position_of_events, x_position_of_events)),
      ), shape=(event_height, event_width),
      dtype=np.uint64).
   ).toarray( )
#</HELPER FUNCTIONS>
#<MAIN FUNCTIONS>
def fast_approximate_extraction(event_structured_array):
   ′″
      This function converts a structured array of events to a 2D static image.
   ′″
   sums=events_to_event_sums(event_structured_array)
   inverted_sums=sums.max( )−sums
   frame=image_histogram_equalization(inverted_sums)
   return frame
def luminance_extraction(event_structured_array, calibration_array):
   ′″
      This function converts a structured array of events to 2D luminance information.
      calibration_array is an array that maps event rates to luminance values.
      its shape is (event_height, event_width, number_luminance_values)
   ′″
   sums=events_to_event_sums(event_structured_array)
   t_us=events_to_event_sums[‘t’].max( )−events_to_event_sums[‘t’].min( )
   t=t_us/1e6 # Convert to seconds
   rates=sums/t
   best_luminance_match=np.argmin(np.abs(calibration_array−rates[ . . . , None]), axis=−1)
   return best_luminance_match
#</MAIN FUNCTIONS>

What is claimed is:

1. A system for noise-enabled static imaging using an event camera, the system comprising:
(a) a dynamic vision sensor configured for capturing image data;
(b) a processor configured to receive captured image data from the dynamic vision sensor; and
(c) a non-transitory memory storing instructions executable by the processor;
(d) wherein the instructions, when executed by the processor, perform the steps comprising:
(i) capturing and recording image data from the dynamic vision sensor;
(ii) aggregating noise events from the recorded image data and recording average noise levels; and
(iii) reconstructing an estimated scene using a calibrated mapping model.

2. The system of claim 1, further comprising:
a data storage device; and
a display.

3. The system of claim 1, wherein the instructions perform further steps comprising:
capturing static scenes at runtime, and recording average noise levels; and
applying histogram equalization with a predetermined number of bins to enhance the contrast of the noise.

4. The system of claim 1, wherein the instructions perform further steps comprising:
capturing static scenes at runtime and recording average noise levels;
performing an inversion of noise to account for an inverse relationship between noise and luminance; and
applying histogram equalization with a predetermined number of bins to enhance the contrast of the noise.

5. The system of claim 4, wherein said inversion of noise comprises an iterative inversion of static information from noise selected from the group of applying classical priors on the scene, applying generative priors for inversion, and creating a forward model of scene to noise and inverting it iteratively.

6. The system of claim 1, wherein the instructions perform further steps comprising:
performing a system calibration by making measurements of known static luminosities;
recording average noise levels over a predetermined period; and
producing a model of calibrated mapping between luminance and noise.

7. The system of claim 1, wherein the instructions perform further steps comprising:
collecting a dataset of pairs of event data and a corresponding static scene;
optimizing a mapping between event data to static scene to produce an optimized model; and
applying the optimized model at runtime to estimate the static scene.

8. The system of claim 7, wherein said mapping is optimized with one or more of a lookup table, a neural network and a linear mapping.

9. The system of claim 1, wherein the instructions perform further steps comprising:
denoising said reconstructed estimated scene.

10. The system of claim 1, wherein the instructions perform further steps comprising:
estimating a static scene at runtime over a specified time scale;
estimating a noise event distribution from the estimate of the static scene;
assigning each event a likelihood of being noise conditioned on the estimated static scene; and
selecting a threshold for denoising from the assigned noise event distribution.

11. The system of claim 10, wherein the instructions perform further steps comprising:
using the selected threshold to separate events into a noise channel and a signal channel.

12. The system of claim 11, wherein the instructions perform further steps comprising:
applying a weighted average selected empirically to the likelihood of being a noise event assignment.

13. A method for noise-enabled static imaging using an event camera, the method comprising:
(a) capturing image data with a dynamic vision sensor;
(b) capturing static scenes at runtime, and recording average noise levels; and
(c) reconstructing the estimated scene using a calibrated mapping model.

14. The method of claim 13, further comprising
performing a system calibration by making measurements of known static luminosities;
recording average noise levels over a predetermined period; and
producing a model of calibrated mapping between luminance and noise.

15. The method of claim 13, further comprising:
capturing static scenes at runtime and recording average noise levels; and
applying histogram equalization with a predetermined number of bins to enhance the contrast of the noise.

16. The method of claim 15, further comprising:
performing an inversion of noise to account for an inverse relationship between noise and luminance prior to histogram equalization.

17. The method of claim 15, wherein the inversion of noise comprises an iterative inversion of static information from noise selected from the group of applying classical priors on the scene, applying generative priors for inversion, and creating a forward model of scene to noise and inverting it iteratively.

18. The method of claim 13, further comprising:
collecting a dataset of pairs of event data and a corresponding static scene;
optimizing a mapping between event data to static scene to produce an optimized model; and
applying the optimized model at runtime to estimate the static scene.

19. The method of claim 13, further comprising:
denoising the reconstructed estimated scene.

20. A method for noise-enabled static imaging using an event camera, the method comprising:
(a) capturing image data with a dynamic vision sensor;
(b) performing calibration by making measurements of known static luminosities and recording average noise levels over a predetermined period, resulting in a calibrated mapping between luminance and noise;
(c) capturing static scenes at runtime, and recording average noise levels; and
(d) reconstructing the estimated scene using the calibrated mapping.

21. The method of claim 20, further comprising:
capturing static scenes at runtime and recording average noise levels;
optionally performing inversion of noise to account for the inverse relationship between noise and luminance; and
applying histogram equalization with a predetermined number of bins to enhance the contrast of the noise.
